(19) United States
(12) Patent Application Publication
(10) Pub. No.: US 2002/0060650 A1
(43) Pub. Date: May 23, 2002

(54) Schematic illustration drawing apparatus and method

(75) Inventors: Shigeru Wakashiro, Tokyo (JP); Masato Hara, Tokyo (JP); Toshihiro Nakayama, Saitama (JP); Shinobu Uezono, Saitama (JP); Atsumi Kaneko, Tokyo (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/983,191

(22) Filed: Oct. 23, 2001

(30) Foreign Application Priority Data
Oct. 25, 2000 (JP) P2000-325544

(51) Int. Cl. G09G 5/00

(52) U.S. Cl. 345/9; 700/83; 345/964

(57) ABSTRACT

A schematic illustration drawing apparatus utilized for drawing a schematic illustration corresponding to a image that is captured by a digital camera or scanner is provided. The apparatus comprises an image indicating processor, drawing processor, transmittance setting processor, and adjusting processor. The image indicating processor indicates the image and illustration on the screen of a display as a first and second layer, so that the illustration is superimposed on the image. The brightness and contrast of the image in the first layer is adjusted by the transmittance of the second layer that is set by the transmittance setting processor, so that the illustration is made prominent from the image. As a result, an operator can easily trace the image on the screen with the drawing processor, as if the operator were drawing the illustration on tracing paper.

### BACKGROUND OF THE INVENTION

1. Field of the Invention

The present invention relates to a schematic illustration drawing apparatus that is utilized to draw the schematic illustration of an image which is displayed on a screen of an image-indicating device, by means of tracing the image.

2. Description of the Related Art

In a photogrammetric measurement that is carried out for a traffic accident to produce a survey map of the accident spot from the photographs, a simple schematic illustration of a general view or survey of the scene is also generally drawn to a general understanding of the scene. Conventionally, the schematic illustration is sketched before or after the measurement. However, the resulting illustration is affected by the ability and experience of the person by whom the illustration is sketched. Further, the examination of the accident spot is required to be prompt since measuring obstructs traffic; however, sketching at the spot prolongs the examination.

Recently, with the progress and spread of personal computers, illustration drawing is getting comparatively easier. Therefore, to overcome the above disadvantage of sketching at the scene, a picture of the traffic accident is taken with a digital still camera and the schematic illustration of the survey image of the accident spot is drawn afterward on the screen of the image indicating device using a personal computer and the appropriate graphics software. Therefore the examination time at the spot is reduced.

However, as for conventional graphics or drawing software, it is quite difficult to distinguish the schematic illustration from the photograph image when the schematic illustration is superimposed on the photograph image displayed on the screen, especially when the photograph image is displayed in full color. Namely, drawing the illustration with conventional graphics software requires labor and time for an operator.

### SUMMARY OF THE INVENTION

Therefore, an object of the present invention is to provide a schematic illustration drawing apparatus and a schematic illustration drawing method that facilitates a schematic illustration drawing which is carried out on a screen of an image indicating device by tracing an image displayed on the screen.

According to the present invention, a schematic illustration drawing apparatus for drawing a schematic illustration corresponding to an image is provided that an image indicating processor, a drawing processor, a transmittance setting processor, and an adjusting processor.

The image indicating processor can indicate the respective image and schematic illustration as a stack of a first layer and a second layer, wherein the second layer is superimposed on the first layer. The drawing processor is for drawing the schematic illustration on the second layer. The transmittance setting processor is to set a transmittance of the second layer. The adjusting processor adjusts brightness and contrast of the image in accordance with the transmittance.

Further, according to the present invention, a schematic illustration drawing method for drawing a schematic illustration corresponding to an image is provided that comprises an image indicating means, a drawing means, a transmittance setting means, and an adjusting means.

The image indicating means is for indicating the respective image and schematic illustration as a stack of a first layer and a second layer, wherein the second layer is superimposed on the first layer. The drawing means is for drawing the schematic illustration on the second layer. The transmittance setting means sets a transmittance of the second layer. The adjusting means adjusts brightness and contrast of the image in accordance with the transmittance.

### BRIEF DESCRIPTION OF THE DRAWINGS

The objects and advantages of the present invention will be better understood from the following description, with reference to the accompanying drawings in which:

FIG. 1 is a perspective view of a system that utilizes a personal computer for a schematic illustration drawing apparatus, which is an embodiment of the present invention;

FIG. 2 is an electric schematic of the schematic illustration drawing apparatus shown in FIG. 1;

FIG. 3 is the main window of the schematic illustration drawing program which is performed on the schematic illustration apparatus;

FIG. 4 schematically illustrates the conceptual relation between an image and a schematic illustration;

FIG. 5 illustrates histograms of an image before and after a brightness value transformation;

FIG. 6 is a flow chart of the main routine for the schematic illustration drawing program;

FIG. 7 is a flow chart of the transmittance setting procedure shown in FIG. 6;

FIGS. 8A to 8C illustrate the changes in the display of the icon while the transmittance setting procedure is executed;

FIG. 9 is a flow chart of the transmittance transform procedure shown in FIG. 7;

FIG. 10 is a flow chart of the brightness value transformation procedure shown in FIG. 9.

### DESCRIPTION OF THE PREFERRED EMBODIMENTS

The present invention is described below with reference to the embodiments shown in the drawings.

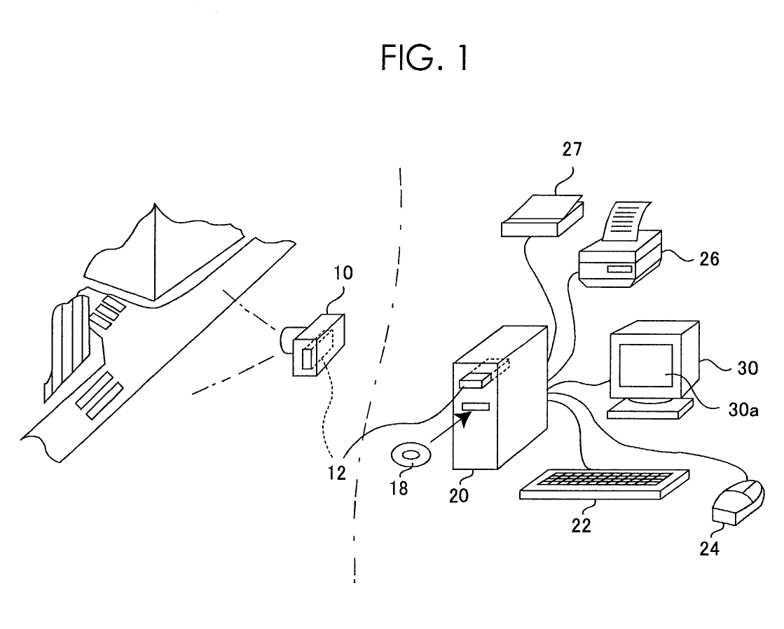

FIG. 1 illustrates the external view of a schematic illustration drawing system in which a personal computer is utilized as a schematic illustration drawing apparatus. The schematic illustration drawing system utilizes a digital still camera 10 as an image input device. When a subject, comprising roads and surrounding buildings for example, is captured by the CCD (not shown) mounted in the digital still camera 10, an optical image of the subject, which corresponds to a frame image, is converted to electric signals and then stored in a recording medium, such as detachable memory card 12, as image data comprised of RGB signals of the pixels. The memory card 12 is also attachable to the personal computer (PC) 20, so that the image data from the digital still camera 10 is transferred to the PC 20 through the memory card 12.

Note that, the image input device for the PC 20 is not restricted to the digital still camera 10. Another good example for the image input device is a scanner 27 that reads an image on a film or printed picture which is photographed by a silver halide film camera. Further, a digital or analog movie camera may be used to obtain the image data. Although in the above embodiment, the image data in the digital still camera 10 is transferred to the PC 20 via the recording medium, such as the memory card 12, the image data of the digital camera 10 or the scanner 27 may be transferred to the PC 20 by an interface which utilizes a channel of a cable, an infrared beam, or a radio signal, and so on.

As an image-indicating device, a liquid crystal display panel (LCD) 30, for example, is connected to the PC 20 and an object image that is transferred from the digital still camera 10 is reproduced on the screen 30a of the LCD 30. As input devices, a keyboard 22 and a pointing device, such as a mouse 24, are connected to the PC 20. The object image displayed on the screen 30a is traced by manipulating the devices. In practice, the outlines or boundary lines of the roads in the image are traced on the screen 30a so that the schematic illustration of the image is superimposed on the image. The schematic illustration may be printed by the printer 26, which is an example of an output device, connected to the PC 20.

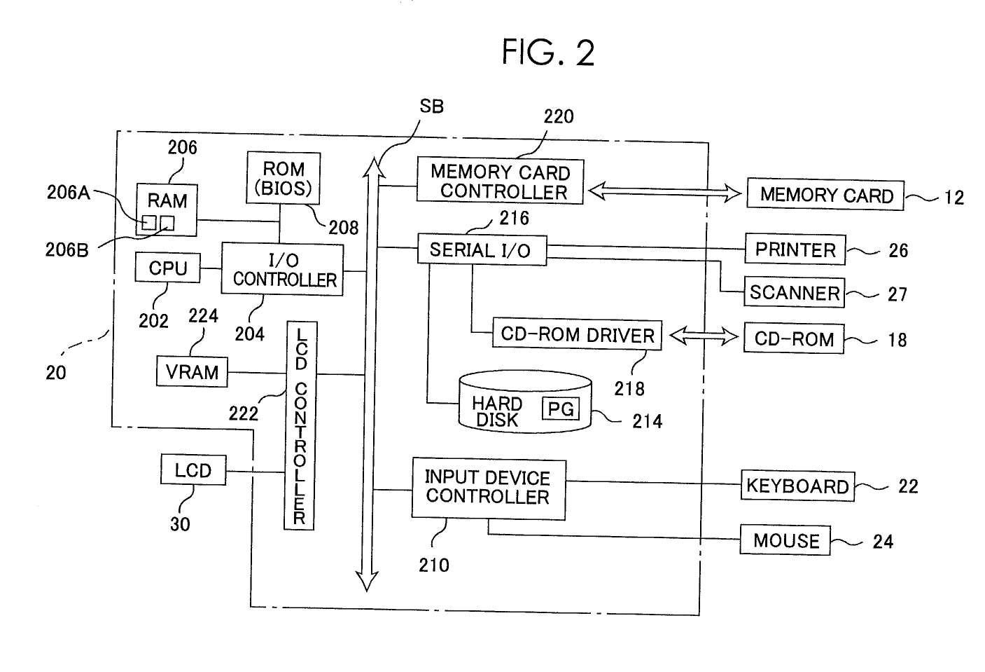

FIG. 2 is a block diagram showing the electric configuration of the schematic illustration drawing apparatus. The personal computer (PC) 20 comprises a microprocessor (CPU) 202, I/O controller 204, memory (RAM) 206, ROM 208, and other peripheral circuits that are not shown in the FIGURE. The CPU 202 integrally controls the PC 20 and the I/O controller 204 controls the input and output of the CPU 202. The memory 206 includes the main memory and other extended memories, a part of which is used for a working area. The basic input-output system (BIOS) is stored in ROM 208. For the operating system, Windows 98 (Microsoft Corp.) may be applied. The I/O controller 204 controls the input and output between the CPU 202 and the circuits connected to the bus SB according to the BIOS.

The keyboard 22 and mouse 24 are connected to the bus SB through the input device controller 210. A nonvolatile storage, such as the built-in hard disk 214, the CD-ROM driver 218, the printer 26 and the scanner 27 are connected to the bus SB via the serial interface (serial I/O) 216. Input and output of serial data between the bus and devices are controlled by serial I/O 216. Further, the bus SB is connected to the memory card 12 through the memory card controller 220, which controls the data input and output, when the memory card 12 is attached to the card slot.

The LCD controller 222 outputs image data from the bus SB into the VRAM 224 and controls the display on the screen 30a of the LCD 30. An example of the LCD 30 is a transmitting type display with the backlight arranged on the backside of the screen.

The schematic illustration program (designated by PG in the FIGURE) for drawing a schematic illustration is preinstalled to the hard disk 214 from the CD-ROM 18, however, the schematic illustration program may be executed from the CD-ROM 18 each time it is required to.

The image data stored in the external recording medium (memory card) 12 is stored as an image file in a predetermined standard format for each frame image. When the PC 20 reads image data from the memory card 12, the image data is decoded and temporally stored in the image data storing area 206A.

The image data storing area 206A is allocated in the RAM 206 and temporally stores the image data that will be indicated on the LCD 30. The image data for one frame image of a subject is represented by brightness value of three-color components, i.e., R (red), G (green), and B (blue), which are set for each pixel of the image. Namely, the image is an image that is comprised of N pixels which are two dimensionally arrayed. The intensity of each color component may be represented by 8 bit data, namely 256 steps of numbers between 0 and 255.

Further, the illustration data storing area 206B is also allocated in the RAM 206. The illustration data storing area 206B temporally stores data which relates to a schematic illustration produced from the subject image displayed on the screen 30a. Hereafter, the data will be referred to as illustration data. The illustration data is comprised of a set of vector data which represents the illustration.

Both image data and the illustration data are read from the RAM 206 and transformed to a predetermined data format and may be stored in a single file allocated in the hard disk 214, when required. Further, the data of the photograph image (image) of the subject or its schematic illustration may be sent to the LCD controller 222. Further, they may be sent to an output device connected to the PC 20, such as the printer 26, so that the photograph image or the schematic illustration is printed. Through the above processes, the illustration data, which is comprised of the vector data, may be rasterized as the occasion demands.

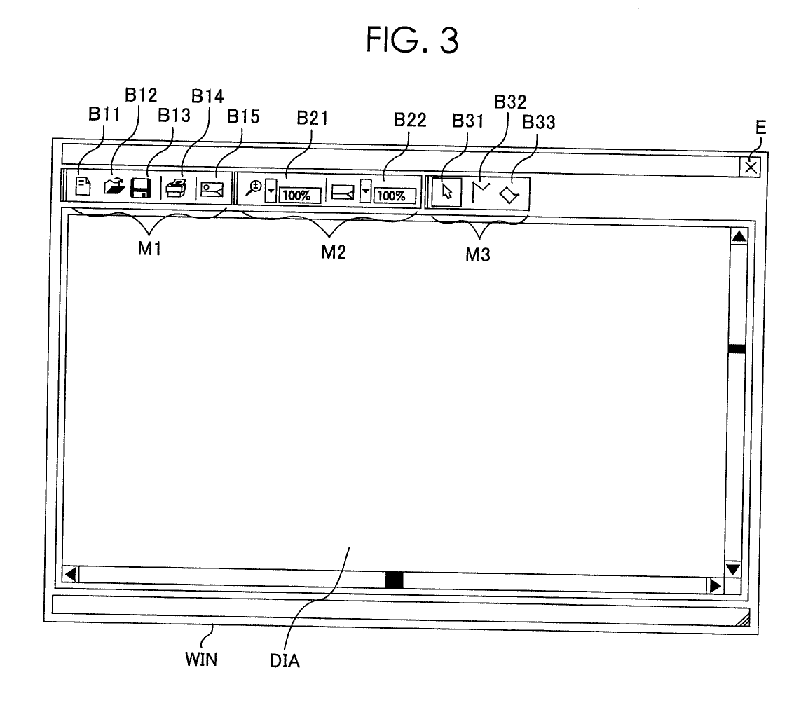

FIG. 3 illustrates an example of the screen for the schematic illustration-drawing program displayed on the LCD 30. A window system and a GUI (graphical user interface) are applied to the system of computer 20. When the schematic illustration-drawing program which is stored in the hard disk 214 is executed, the main window WIN for the schematic illustration-drawing program is indicated on the screen 30a of the LCD 30. The main window WIN has an image indicating area DIA where an original photograph image and a schematic illustration are superimposed and displayed. Outside of the image indicating area DIA, the tool bars M1-M3 are arranged along the upper side of the image indicating area DIA. Each tool bar M1-M3 comprises a plurality of icons, each of which relates to a certain process or function. At the upper right of the main window WIN, the close box E is disposed. When the mouse pointer on the screen is moved onto the close box E by operating the mouse 24 and a button of the mouse 24 is clicked, the main window WIN is closed and the schematic illustrating-drawing program is terminated.

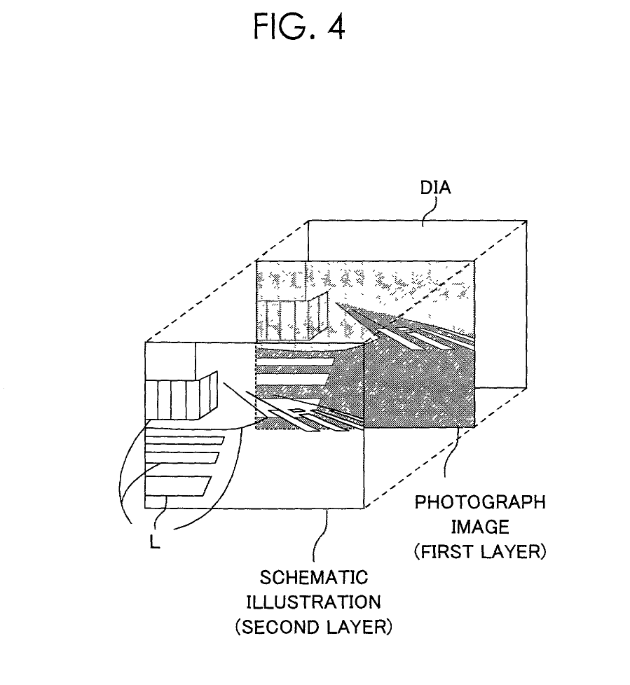

FIG. 4 is the conceptual illustration that represents the relations between the photograph image and a schematic illustration in the image indicating area DIA. Conceptually, there are two stratified layers, the first and second layers, in the image indicating area DIA. The first layer is for indicating a photograph image and the second layer is for indicating a schematic illustration. The second layer is conceptually disposed over the first layer of the same size. The second layer is virtually transparent so that an image on the first layer which is disposed beneath the second layer is visible through the second layer. The diagram elements which are indicated by the lines L are drawn on the second layer by operating the keyboard 22 or the mouse 24.

The tool bar M1 indicated in FIG. 3 contains four icons B11, B12, B13, and B14, for example. The icons B11-B14 are used to create, open, save, and print a schematic illustration, respectively. The icon B15 is used to place a (import) photograph image or image onto the image indicating area DIA.

The tool bar M2 contains icons that are used to set matters which relate to the image indicating area DIA. For example, the icon B21 is used to set a scale of a photograph image and a schematic illustration displayed on the image indicating area DIA. Namely the view size of a photograph image and a schematic illustration is magnified or reduced in accordance with the set scale. The icon B22 is used to set transmittance of the first layer, so that the prominence of the schematic illustration is controlled. The icons B21 and B22 function as a pull down menu form with multiple choices, so that an appropriate scale or transmittance value can be selected from the menu.

The tool bar M3 contains icons that are utilized in the edit operations which create or modify elements in a schematic illustration drawing. For example, the icons B31, B32, and B33 are used to set the following modes for the edit operations, ‘select mode’, ‘multiple line mode’, and ‘polygon mode’, respectively. At the initial state, just after the main window WIN is opened, the ‘select mode’ is selected by default.

Next, the transmittance, which is set by the function of the icon B22, is explained. A value of the transmittance is an index for adjusting brightness and contrast of an image. When the transmittance is set to a higher value, brightness and contrast of an image is maintained closer to the original photograph image. When the transmittance is set to a lower value, brightness of an image is set to a higher level and contrast is made flatter. Namely, the image becomes whitish, as if the image is covered with a white mask.

An image of roads and buildings comprises a variety of colors, so that it is difficult to discriminate lines of a superimposed illustration from the image, particularly when the colors of the image and the color of drawing lines used in the illustration are similar. Therefore, in the present embodiment, the brightness of the image is set at a high level and the contrast of the image is made weak, so that the schematic illustration superimposed on the image can be easily designated from the whitely adjusted image. As a result, efficiency of drawing a schematic illustration is improved and also fatigue of an operator is reduced.

On an image-indicating device, rotary switches for adjusting brightness and contrast of the screen are generally provided. However the above rotary switches are for adjusting the whole image indicated on the screen, thus the adjustment is not only subjected to a photograph image but also to a schematic illustration on the screen. Namely, it does not facilitate distinction of the illustration from the photograph image. Further, the adjustment might disadvantageously affect the drawing of the schematic illustration. On the other hand, in the present embodiment, the brightness and contrast of the schematic illustration are fixed while those of the photograph image are adjusted, so that the illustration can be made prominent in contrast to the photograph image.

Substantially, in the present embodiment, the brightness and contrast adjustment for the photograph image is carried out by a brightness value transformation for each pixel value that corresponds to the respective R, G, and B signals of the image data. For the brightness value transformation, a well-known linear or nonlinear brightness value transformation may be applied.

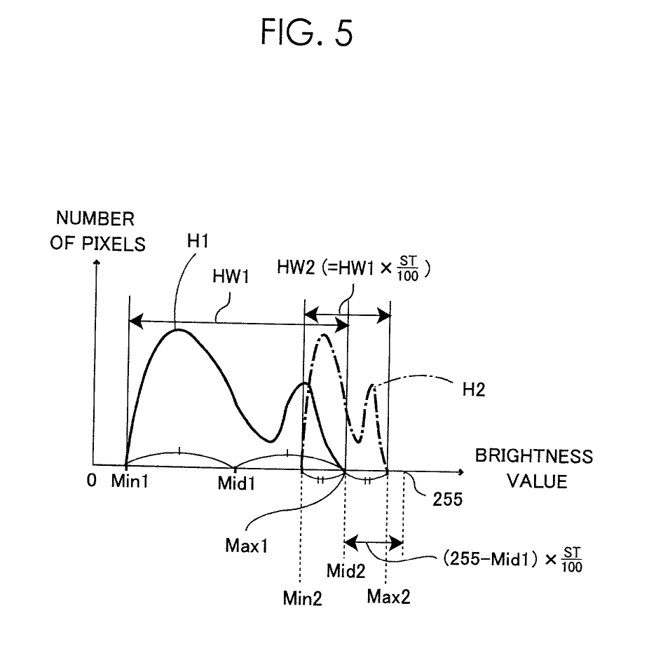

With reference to FIG. 5, the brightness value transformation based on the transmittance value in the present embodiment will be explained in detail. FIG. 5 shows histograms of image data before and after the transformation. The abscissa represents the brightness value (range between [0,255]) and the ordinate represents the number of pixels. The histogram H1 of the image data before the transformation is indicated with the solid line and the histogram H2 after the transformation is indicated with the phantom line. The brightness value of the image data before the transformation are distributed in the range HW1, which is between the minimum value Min1 (Min1≧0) and the maximum value Max1 (Max1≦255). When the transmittance of the first layer is set for ST % (0≦ST≦100) , the range HW1 for the brightness value of the image data is narrowed to the range HW2 (HW1·ST/100) after the transformation, so that the contrast of the image is flattened.

Further, after the brightness value transformation, the minimum value Min1 and the maximum value Max1 of the brightness value are shifted to the higher level, which are indicated by minimum value Min2 and the maximum value Max2 and the median Mid1 of the histogram H1 is transformed to the median Mid2 of the histogram H2, so that the image is brightened. In concrete term, the median Mid2 is represented by the formula (255-Mid1)·ST/100, where ST is the transmittance (%) of the first layer. Namely, the median Mid2 of the histogram H2 is settled at a certain value between Mid1 and 255, i.e. the maximum value of the brightness value, in accordance with the transmittance ST. The brightness value transformation is applied to each of the R, G, and B color components of the image data and each histogram of the R, G and B color components is shifted to the higher level, so that a whitish image is obtained.

As described above, according to the present embodiment of a schematic illustration drawing apparatus, the brightness and contrast of a photograph image are automatically adjusted by a transmittance of the first layer that is set by an operator. Namely, the schematic illustration can be simply made prominent from the photograph image. Further, the schematic illustration of the photograph image can be drawn as if the photograph image were being traced on translucent paper, such as tracing paper, thus drawing becomes quite easy.

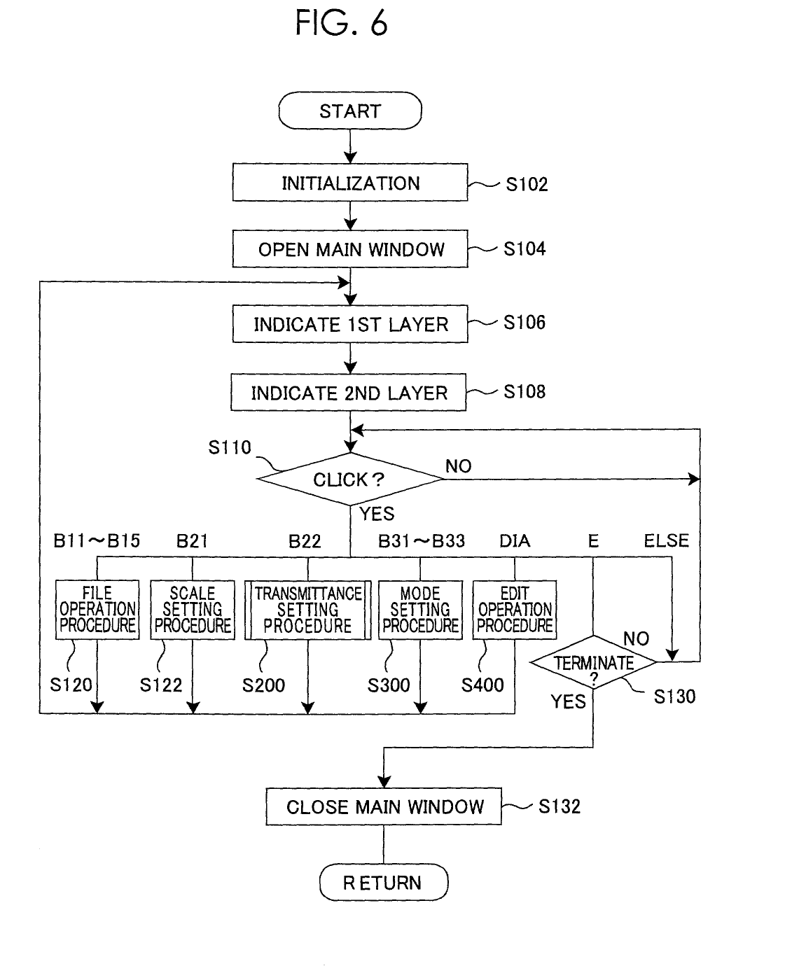

With reference to FIG. 6 to FIG. 9, the schematic illustration drawing process will be explained in detail. FIG. 6 indicates the flow chart of the main routine for the schematic illustration drawing program.

When the schematic illustration drawing program is started, the initial setup is executed in Step S102 and the ‘select mode’ is initially selected for the edit operations. To indicate the selection of ‘select mode’, the icon B31 is displayed as if it is depressed. Further, both parameter MC, which represents the scale of the photograph image and the schematic illustration, and parameter ST, which represents the transmittance of the first layer, are set to 100 as an initial value.

Next, in Step S104, the main window WIN, which is shown in FIG. 3, is displayed on the screen and at the numeral indicating areas of the icon B21 and B22, which represent the scale and the transmittance, the current values ‘100%’ are respectively indicated. In Steps S106 and S108, the photograph image of the first layer and the schematic illustration of the second layer are displayed on the image indicating area DIA in order. Note that, in the initial state, none of the image data and illustration data, which is to be displayed on the screen, are in the RAM 206A and RAM 206B, so that no image is displayed on the image indicating area DIA.

After Step S108, the process waits for an input of a click at Step S110. When the mouse 24 is clicked, the process proceeds to one of the branch processes, which will be described in the following, in accordance with the position of the mouse pointer at the moment.

When the mouse 24 is clicked in the tool bar M1, namely when the mouse 24 is clicked on one of the icons B11 (create), B12 (open), B13 (save), B14 (print), or B15 (import image), it proceeds to the file operation procedure (Step S120) and the procedure that corresponds to the selected icon is executed. When the icon B11 (create) is clicked, the illustration data storing area 206B is cleared, so that the schematic illustration displayed on the second layer of the image indicating area DIA is cleared for a new illustration to be drawn. When the icon B12 (open) is clicked, the image data or illustration data, which is stored in the hard disk or other nonvolatile storage, is readout from the storage, so that an operator may add a new diagram element to the illustration or modify the old ones. When the icon B13 (save) is clicked, the data which correspond to the currently indicated photograph image and the schematic illustration are both saved to a file with a predetermined format that is able to compound each of the data. When the icon B14 (print) is clicked, the dialog box (not shown) for the printing process is opened, so that the printer 26 may print the schematic illustration on the screen. When the icon B15 (import image) is clicked, the dialog box (not shown), which is used to select an image to be displayed on the first layer of the image indicating area DIA, is opened.

When the mouse 24 is clicked on the icon B21 (scale) of the tool bar M2, the process proceeds to the scale setting procedure (Step S122) and the scale parameter MC may be renewed to a new value. Further, when the mouse 24 is clicked on the icon B22 (transmittance) of the tool bar M2, it proceeds to the transmittance setting procedure (Step S200), which sets the transmittance of the first layer, so that the transmittance ST may be renewed.

When the mouse 24 is clicked on one of the icons in the tool bar M3, i.e., the icon B31 (select mode), the icon B32 (multiple line mode), or the icon B33 (polygon mode), the mode setting procedure (Step S300) is executed and a mode for the edit operations is set or altered. In Step S300, the mode for edit operations may be altered to a new mode which is selected by a mouse click. Simultaneously, to indicate the selection of the icon, the selected icon is displayed as if it is depressed while the other icons are flattened. For example, when the icon B33 for ‘polygon mode’ is clicked while the icon B31 for ‘select mode’ has been selected, the mode is altered to the ‘polygon mode’ and the icon B33 for ‘polygon mode’ is displayed in a depressed state to indicate the ‘polygon mode’ is selected, and the icons B31 and B32 for ‘select mode’ and ‘multiple line mode’ are flattened to indicate that they are not selected.

When the mouse 24 is clicked while the mouse pointer is in the image indicating area DIA, the edit operation procedure (Step S400) is executed. Namely, the edit operations for drawing a schematic illustration are carried out in accordance with the current mode selection. The ‘select mode’, is a mode to select an object that is comprised of diagram elements, which are indicated in the image indicating area DIA, and to magnify or reduce the scale of the selected object, or to set or alter the width, type or color of the segments, for example. The ‘multiple line mode’ is a mode for drawing joint segment lines (or curves) which are comprised of successive connections between each point where the mouse 24 is clicked. Further, the ‘polygon line mode’ is a mode for drawing an arbitrary polygon which is defined by a plurality of mouse clicks. The edit operations are further not detailed, since the functions in each of the modes for the edit operations are similar to the conventional draw software. Note that, the mode for drawing a circle, an ellipse, and so on, may be added as the occasion demands.

To exit from the edit operations, a pop-up menu (not shown), which is displayed in the image indicating area DIA, may be used. Namely, when the right button of the mouse 24 is clicked in the image indicating area DIA, the pop-up menu appears and the ‘exit’ item is displayed. By selecting the ‘exit’ item, the edit operation procedure of Step S400 ends.

When each file operation procedure (Step S120), the scale setting procedure (Step S122), the transmittance setting procedure (Step S200), the mode setting procedure (Step S300), and the edit operation procedure (Step S400) ends, the process returns to Step S106 and Steps S106 and S108 are executed, so that the photograph image and the schematic illustration are altered to a new image and illustration in accordance with the current conditions. Then the process again waits for a click input from the mouse 24 at Step S110.

When the mouse 24 is clicked at the close box E, an end message (not shown) is displayed and whether to terminate the program is determined by the operator (Step S130). When it is determined to terminate the program, image data and illustration data may be saved (Step S132), if needed, and then the main window WIN is closed. Namely, the schematic illustration drawing program is terminated. Note that, when it is determined not to terminate the program in Step S130 or the mouse 24 is clicked at a place out of the icons or areas described above, the process returns to Step S110.

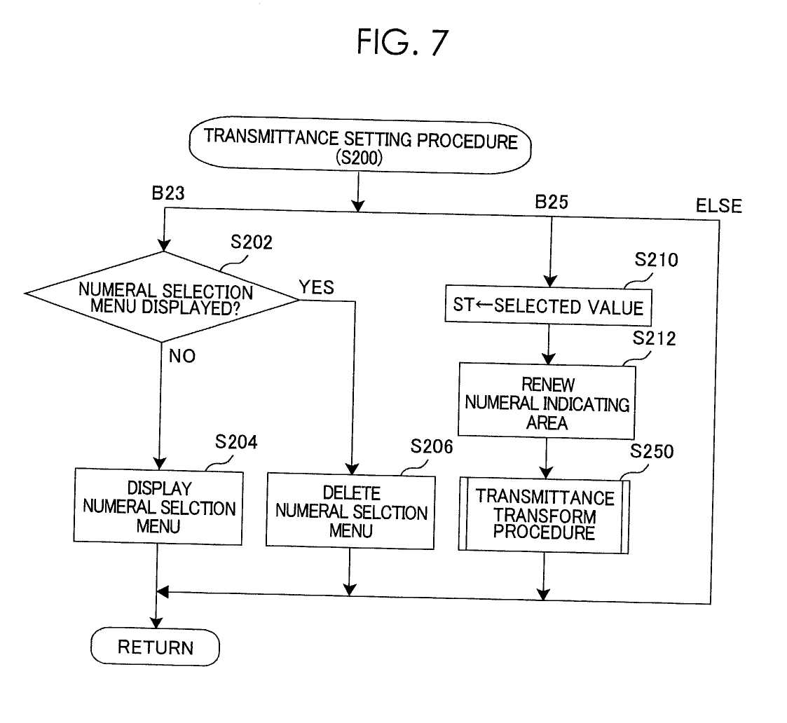

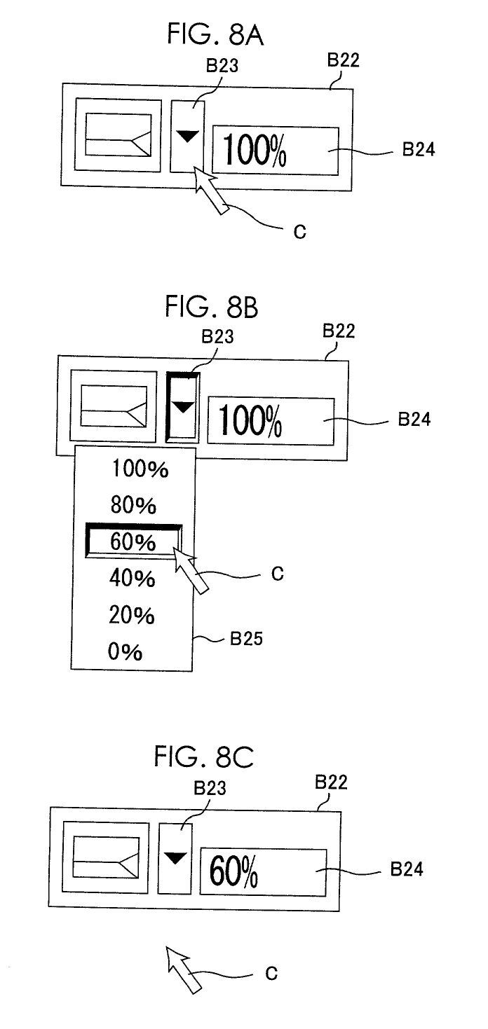

FIG. 7 is the detailed flow chart of the transmittance setting procedure of Step S200 shown in FIG. 6. FIGS. 8A-8C illustrate changes in the display of the icon B22 for the ‘transmittance’. The icon B22 for the ‘transmittance’, has the arrow box B23 and the numeral indicating area B24. The arrow box B23 is for indicating the pull-down menu or list box for the numeral selection menu (see reference number B25 in FIG. 8B). The numeral indicating area B24 displays the currently selected transmittance ST.

As shown in FIG. 8A, when the mouse 24 is clicked while the mouse pointer C is disposed in the arrow box B23 at Step S110 (see FIG. 6), Step S202 is then executed and whether the numeral selection menu B25 is already displayed is determined. When it is determined that the menu has not been displayed, the numeral selection menu is displayed as it is shown in FIG. 8B (Step S204). When the mouse 24 is clicked on the arrow box B23 in FIG. 8B, the process proceeds to Step S206 from Step S202 and then the screen returns to the state of FIG. 8A.

As shown in FIG. 8B, when the mouse 24 is clicked while the mouse pointer C is in the area of the numeral selection menu B25, the value, which the mouse pointer C indicates, is selected and will be substituted to the transmittance parameter ST (Step S210). In FIG. 8B, the case when the numeral ‘60%’ is indicated by the mouse pointer C is shown for example. As a result of the selection, the transmittance ST indicated in the numeral indicating area B24 is altered to the newly selected value, i.e. ‘60%’ in this example (Step S212). In parallel with the above alternation, the numeral selection menu B25 is closed and then the image data for the first layer is transformed to the new image data in accordance with the new transmittance ST in the transmittance transform procedure of Step S250.

The transmittance setting procedure completes when Step S204, S206 or S250 ends and the process returns to Step S110 of FIG. 6. Therefore, as shown in FIG. 8A through FIG. 8C, to replace the transmittance ST from 100% to 60%, the transmittance setting procedure (Step S200) is carried out at least twice.

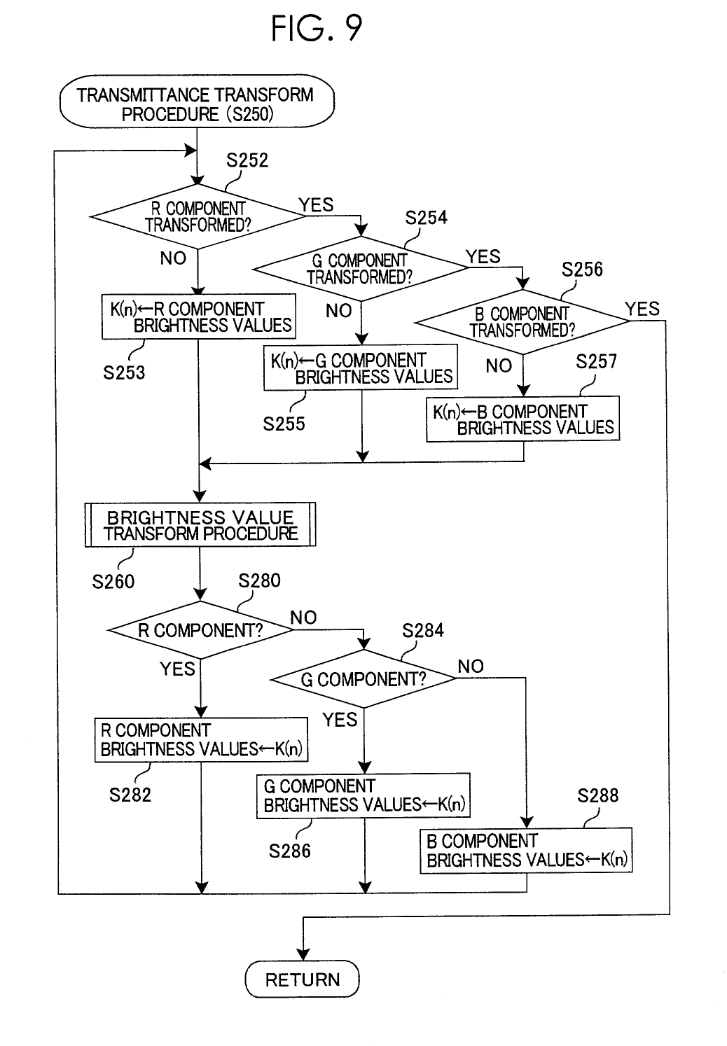

FIG. 9 is the detailed flow chart of the transmittance transform procedure (Step S250 in FIG. 7). In this process, the brightness value transformation is subjected to each of RGB components of an image which is comprised of N pixels. At first, whether the brightness value transformation was performed for the R component is checked at Step S252. When the brightness value transformation has not been performed for the R component, the process proceeds to Step S253 and the brightness values for N pixels of the R component are sequentially substituted for the variables K(n), where 1≦n≦N. In the succeeding Step S260, the brightness value transformation is applied to the variables K(1) to K(N) as will be described later.

When Step S260 ends, the process proceeds to Step S280 and whether the R component is the latest color component to which the brightness value transformation was applied is checked. In the case where the last color component to which the brightness value transformation was applied is the R component, the values of the current variables K(1) to K(N) are stored in the RAM 206 as the brightness values of the R component and then the process returns to Step S252.

In Step S252, whether the brightness value transformation was performed to the R component is again checked. By this time, the brightness value transformation has already been applied to the R component, thus the process proceeds to Step S254. In Step S254, whether the brightness value transformation was performed to the G component is checked. When the brightness value transformation has not been applied to the G component, the process proceeds to Step S255 and the brightness values for the G component are substituted into the variables K(n) (1≦n≦N). Then, Step S260 is executed, and the brightness value of the G component are transformed to the new values by the brightness value transformation. After the completion of Step S260, the process proceeds to Step S284 via Step S280, since the last color component to which the brightness value transformation was applied is the G component. In Step S284, whether the G component is the last color component to which the brightness value transformation was applied is checked. When it is determined that the brightness value of G component is the latest color component to which the brightness value transformation was applied, Step S286 is then executed. In Step S286, the values of the current variables K(1) to K(N) are stored in the RAM 206 as the brightness values of the G component and then the process returns to Step S252.

By this time the brightness value transformation is already applied to the R and G components, thus the process proceeds to Step S256 via Step S252 and S254. In Step S256, whether the brightness value transformation was performed for the B component is checked. When the brightness value transformation has not been applied to the B component, the process proceeds to Step S257 and the values of the variables K(n) are altered by the brightness values of the G component. Next, Step S260 is executed, and the brightness values of the B component are transformed to the new values by the brightness value transformation. After the completion of Step S260, the process proceeds to Step S288 via Step S280 and S284, since the last color component to which the brightness value transformation was applied is the B component. In Step S288, the values of the current variables K(n) (1≦n≦N) are stored in the RAM 206 as the brightness values of the B component and then the process returns to Step S252.

When the brightness value transformations for all color components R, G, and B are completed, Step S252, S254, and S256 are then carried out in order, and then this transmittance transform procedure (Step S250) ends. Namely, the process returns to Step S106 shown in FIG. 6 and the image on the screen is redrawn according to the transformed brightness values of the RGB color components stored in the RAM 206.

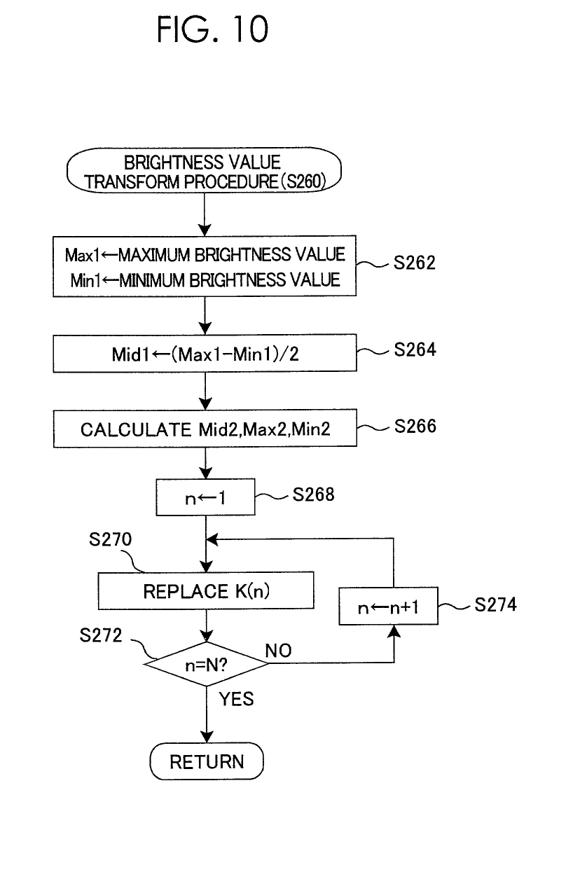

FIG. 10 illustrates the detailed flow chart of the brightness value transform procedure of Step S260. In Step S262, the maximum value Max1 and the minimum value Min1 of the variables K(1) through K(N), which corresponds to the brightness values, are obtained and then the intermediate value or median Mid1 between Max1 and Min1 is calculated in Step S264. In Step S266, the maximum value Max1, the minimum value Min1, the median Mid1, and the transmittance ST are introduced to the following equations (1) through (3), so that the median Mid2, maximum value Max2, and minimum value Min2 for the transformed brightness values are calculated.

Mid2=(255−Mid1)×100-ST/100+Mid1 (1)

Max2=Mid2+(max1−Mid1)×ST/100 (2)

Min2=Mid2−(Mid1−Min1)×ST/100 (3)

When Step S266 ends, the brightness value transformation, which is represented by Equation (4), is applied to each K(n) (n=1,2, . . . ,N) through Steps S268-S274, and the values of each K(n) are replaced by new values obtained by Equation (4).

$$K ( n ) ← ( Max 2 - Min 2 ) \times \frac{K ( n ) - Min 1}{Max 1 - Min 1} + Min 2 \qquad ( 4 )$$

Namely, in Step S268, the initial value 1 is set for the parameter n and the brightness value transformation is then performed to K(n=1) in Step S270, as described in Equation (4) . In Step S272, whether the parameter n reached the value N is determined. If n is below N, the parameter n is increased to n+1, in Step S274, then it returns to Step S270. For example, when the value of n is 1 in Step S272, n is replaced by 2 in Step S274. Step S270 is repeated until the parameter n reaches N, namely until the condition ‘n=N’ is confirmed in Step S272. Consequently, every value of K(n) (n=1, 2 . . . ,N) for each of N pixels, is replaced by the transformed values obtained by the above brightness value transformation.

When the condition ‘n=N’ is confirmed in Step S272, the brightness value transform procedure completes and the process returns to Step S280 in FIG. 9.

Note that, in the present embodiment, a linear transformation is adopted for the brightness value transformation, as indicated in Equation (4) , however, the transformation is not limited to a linear form but also a non-linear transformation may be adopted.

As described above, the schematic illustration drawing apparatus of the present embodiment can produce a schematic illustration by tracing a photograph image or a drawing image on the screen of an image indicating device. The brightness value transformation for each color component of the first layer, on which the photograph image is displayed, is controlled by adjusting the transmittance of the first layer. Further the brightness value transformation is only used for the photograph image. Therefore, the schematic illustration can be easily made prominent form the photograph image by making the photograph image whitish. Consequently, tracing with tracing paper is emulated on the screen of a computer, thus it improves the performance of the drawing or tracing operation. Further, a value of the transmittance can be selected from the list box by operating the mouse pointer, so that both brightness and contrast of the photograph image are simultaneously and easily set or replaced. Furthermore, the schematic illustration drawing program is recorded in a CD-ROM, so that it can be executed by any computer in which the program is installed. Note that, the apparatus is also effective for transforming the data of a drawing to vector data.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2000-325544 (filed on Oct. 25, 2000) which is expressly incorporated herein, by reference, in its entirety.

1. A schematic illustration drawing apparatus utilized for drawing a schematic illustration corresponding to an image and comprising:
an image indicating processor that is able to indicate said image and said schematic illustration as a stack of a first layer and a second layer, respectively, wherein said second layer is superimposed on said first layer;
a drawing processor that is for drawing said schematic illustration on said second layer;
a transmittance setting processor that is to set a transmittance of said image; and
an adjusting processor that adjusts brightness and contrast of said image in accordance with said transmittance.

2. An apparatus according to claim 1, wherein said image is captured by a camera.

3. An apparatus according to claim 1, wherein said image is captured by a scanner.

4. An apparatus according to claim 1, wherein said adjusting processor adjusts said brightness and said contrast of said image by performing a brightness value transformation.

5. An apparatus according to claim 4, wherein said transmittance is set within a range from 0 to 100 percent and a distribution range of brightness values of said image is reduced by an amount of said transmittance by said brightness value transformation.

6. An apparatus according to claim 4, wherein a distribution range of brightness values of said image is translated to a higher level by said brightness value transformation.

7. An apparatus according to claim 1, wherein said image comprises a plurality of color components.

8. An apparatus according to claim 7, wherein said adjusting processor adjusts said brightness and said contrast of said image by performing a brightness value transformation to each of the brightness values of said color components.

9. An apparatus according to claim 8, wherein said transmittance is set within a range from 0 to 100 percent and a distribution range of gray levels brightness values for each of said color components is reduced by an amount of said transmittance.

10. An apparatus according to claim 8, wherein a distribution range of brightness values for each of said color components is translated to a higher level by said brightness value transformation.

11. An apparatus according to claim 7, wherein said color components comprise red, green, and blue color components as three primary colors.

12. An apparatus according to claim 1, wherein said schematic illustration is comprised of vector data.

13. A schematic illustration drawing method utilized for drawing a schematic illustration corresponding to an image and comprising:
an image indicating means for indicating respective said image and said schematic illustration as a stack of a first layer and a second layer, wherein said second layer is superimposed on said first layer;
a drawing means for drawing said schematic illustration on said second layer;
a transmittance setting means to set a transmittance of said second layer; and
an adjusting means to adjust brightness and contrast of said image in accordance with said transmittance.
